(19) United States
(12) Patent Application Publication
(10) Pub. No.: US 2008/0275725 A1
(43) Pub. Date: Nov. 6, 2008

(54) Method, system, and computer program product for identifying medical liability claims

(76) Inventors: Gregory Hach, New York, NY (US); Michael Rose, Purchase, NY (US); Ling Ju Wu, Flushing, NY (US)

Correspondence Address: KILPATRICK STOCKTON LLP, 1100 Peachtree Street, Suite 2800, ATLANTA, GA, 30309, US

(21) Appl. No.: 11/797,149

(22) Filed: May 1, 2007

(51) Int. Cl. G06Q 50/00

(52) U.S. Cl. 705/2

(57) ABSTRACT

An embodiment of the invention is a data mining method, system, and computer program product for correlating drug, diagnosis, and/or treatment codes to permit health plans to recover, from a liable third party, costs expended on an insured.

### FIELD OF THE INVENTION

The present invention relates generally to a method, system, and computer program product for identifying medical liability claims. More particularly, but not by way of limitation, the present invention is a data mining method, system, and computer program product for correlating drug, diagnosis, and/or treatment codes to permit health plans to recover, from a liable third party, costs expended on an insured.

### BACKGROUND OF THE INVENTION

A problem that health plans face is recovering money from a third party for medical care that is expended on health plan participants for injuries arising from the negligence of the third party, whether it be the result of the use of a dangerous prescription drug or some other reason that gave rise to the injury. The term “injury” as used herein is not meant to be limiting and would encompass conditions, afflictions, illness, etc. The term “health plan” as used herein is not meant to be limiting in any way, but broadly refers to an individual or group plan that provides for the financing or delivery of health care services to persons enrolled in the plan. Examples of health plans include HMOs, insured plans, preferred provider organizations, etc. Further, health plans may be employer or union provided, for example, labor union health plans.

In the United States, health plans use standard coding to identify prescription drugs, diagnosis, and treatments. For example, codes known as NDC (National Drug Code) codes are used to identify prescription drugs. Codes known as ICD (International Classification of Diseases) codes, for example, ICD-9 and ICD-10, are diagnosis codes. CPT (Current Procedural Terminology) codes are used to identify certain treatments. Accordingly, an MRI, X-ray, or any type of surgical procedure will have a specific treatment code, and a cancer or any illness, injury or condition will have a diagnosis code.

As noted above, health plans have the ability to recover damages or assert a lien in the event the health plan expends funds for an injury to one of its members. That is, health plans become “subrogated” to the rights of its insured. To identify this right of subrogation, health plans have traditionally sent personal letters to its members who, as an example, have been diagnosed with a particular injury, and informing the member that the injury may be linked to a certain type of prescription drug. The letter is based simply on a selective piece of data, e.g., diagnosed injury, and is sent to members who may or may not have been prescribed the drug at issue. Even if the member was prescribed the drug, this process is dependent on the member affirmatively responding to the health plan. This process is inefficient and costly to a health plan, both in terms of somewhat blindly sending out the letters and failing to be informed of the right of subrogation.

Accordingly, there is need for a data mining method, system, and computer program product for correlating drug, diagnosis, and/or treatment codes to permit health plans to recover, from a liable third party, costs expended on an insured.

### SUMMARY OF THE INVENTION

An embodiment of the present invention is a computer implemented method for identifying medical liability claims, comprising the steps of executing a search criteria for searching a data record of at least one plan participant of a health plan, wherein the search criteria is designed to identify a potential claim against a third party from which the health plan may recover health care costs expended on the at least one plan participant. The method further comprises automatically correlating at least two identification codes associated with the at least one plan participant chosen from a group consisting of a drug code, a diagnosis code and a treatment code; identifying the at least one plan participant as satisfying the search criteria; and identifying the potential claim against the third party.

A further embodiment of the present invention is a computer readable medium on which is encoded program code, the program code comprising: a program code for executing a search criteria for searching a data record of at least one plan participant of a health plan, wherein the search criteria is designed to identify a potential claim against a third party from which the health plan may recover health care costs expended on the at least one plan participant; program code for automatically correlating at least two identification codes associated with the at least one plan participant chosen from a group consisting of a drug code, a diagnosis code and a treatment code; program code for identifying the at least one plan participant as satisfying the search criteria; and program code for identifying the potential claim against the third party.

Another embodiment of the present invention is an automated system for identifying medical liability claims, comprising: a processor; and at least one database communicatively coupled to the processor, wherein the at least one database comprises: a data record of at least one plan participant of a health plan; and at least two identification codes associated with the at least one plan participant chosen from a group consisting of a drug code, a diagnosis code and a treatment code. The system further comprises a correlation engine of the processor for correlating the data record of at least one plan participant to a potential claim against a third party from which the health plan may recover health care costs expended on the at least one plan participant. Additionally, the system comprises a user interface for identifying the at least one plan participant and for identifying the potential claim against the third party.

### BRIEF DESCRIPTION OF THE DRAWINGS

In the drawings:

FIG. 1 illustrates an embodiment of the present invention;

FIG. 2 illustrates a further embodiment of the present invention;

FIG. 3 illustrates another embodiment of the present invention;

FIG. 4 illustrates a system architecture of an embodiment of the present invention; and

FIG. 5 illustrates a flow diagram of an embodiment of the present invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

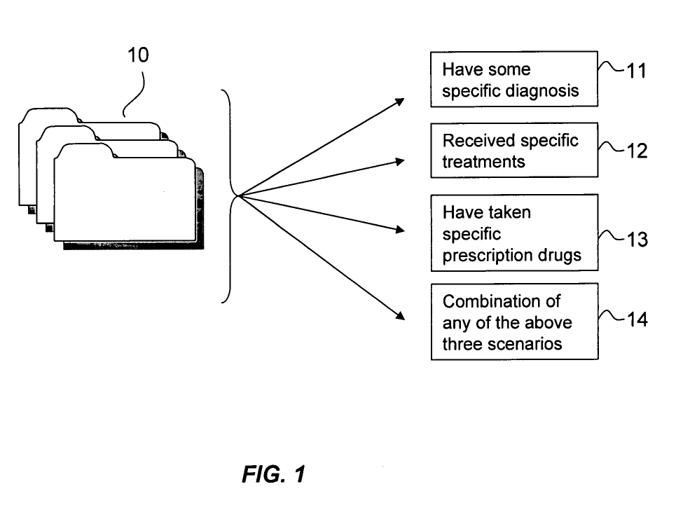

Referring to FIG. 1, an embodiment of the present invention is an application that enables users, for example, health plans such as labor union health plans, to mine all member-related data files which, for example, may be in Excel format, located in specified folders 10 and return lists of members that fit into the following categories: (1) Have some specific diagnosis 11; (2) Received specific treatments 12; (3) Have taken specific prescription drugs 13; or (4) A combination of any of the three scenarios 14.

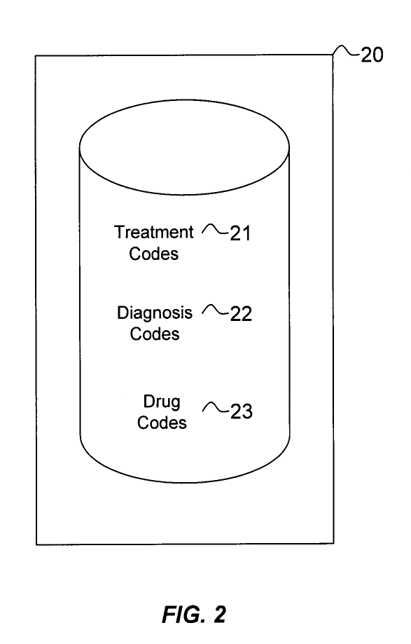

Referring to FIG. 2, the source of the data may be from the health plans themselves 20 or vendors used by the health plans who store and manage the data. The types of data may include the following: (1) treatment codes 21; (2) diagnosis codes 22; and/or (3) drug codes 23. The treatment codes 21 include, for example, specific numbered codes (in some circumstances have a letter as well) identifying specific forms of medical treatment. The diagnosis codes 22, include, for example, data containing information regarding a plan member's diagnosis. The drug codes 23 include, for example, data identifying which drugs were prescribed to member.

The data files from the health plans or vendors may be in a variety of formats, e.g., Excel format. Further, Excel data may be in one particular Excel worksheet or spread out in multiple worksheets. Embodiments of the present invention is compatible with a variety of operating systems, e.g., Windows XP. Users can create, save and edit mappings of their formatted files to a standard format in an application of the present invention. As data files may be in various formats from different health plans or vendors, an embodiment of the present invention, provides for the following standard formats (list of data points) that other formats can be mapped.

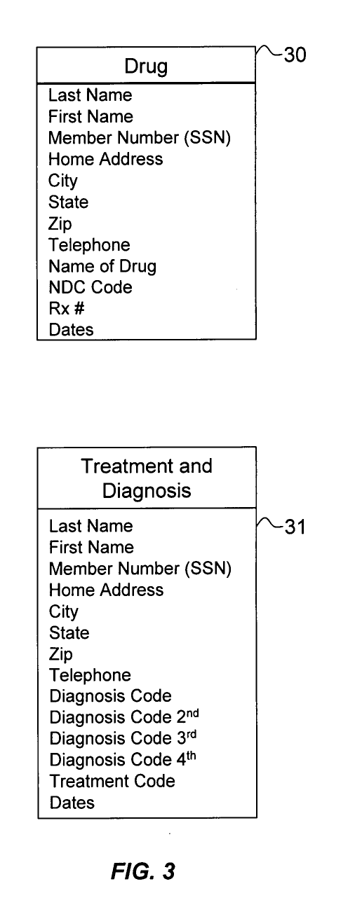

Referring to FIG. 3, an example of the formats of the two sets of data files are as follows: (a) Drug Data File 30: Last Name, First Name, Member Number (SSN), Home Address, City, State, Zip, Telephone, Name of Drug, NDC Code, Rx #, and Dates; (b) Treatment and Diagnosis Data File 31: Last Name, First Name, Member Number (SSN), Home Address, City, State, Zip, Telephone, Diagnosis Code, Diagnosis Code 2^{nd}, Diagnosis Code 3^{rd}, Diagnosis Code 4^{th}, Treatment Code and, Dates.

A functionality of an embodiment of the present invention allows the users to specify a file or folder of all the data, search for a specific treatment, diagnosis and drug code, and return a list of plan members (with information such as name, address, etc. . . . ) that fit the criteria. Further, users are able to search a treatment, diagnosis or drug group. For example, if diagnosis code XXX.X is a specific type of lung cancer, the diagnosis group would be XXX, which is inclusive of all types of lung cancer. Users also have the ability to search for a very specific diagnosis code, for example, by using an root expander “*” to retrieve all cancers that fall under the entered code.

A further functionality of an embodiment of the present invention enables the users to export search results to a number of formats. One example is the Excel format where the users can export the search results into an Excel spreadsheet. Another example is the letter (.Doc) format where users can export the search results automatically or manually into a standard MS Word letter that can be mailed automatically or manually, directly to members. Limits may be established on the export function if the search results return a very large number of patients, e.g., 1000 members.

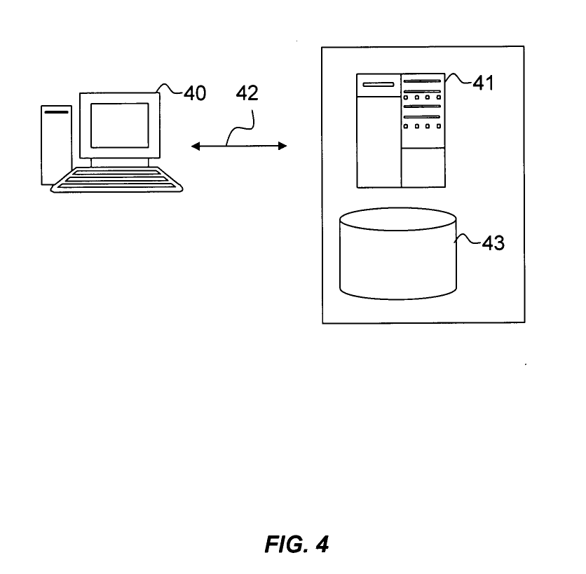

FIG. 4 illustrates a system architecture of an embodiment of the present invention. One or more user terminals 40 are communicatively coupled to a server 41 via a communications network 42. One or more databases 43 are communicatively coupled to the server 41, wherein the databases 43 include: member information; treatment, diagnosis, and drug codes associated with the members; legal information and alerts related to potential medical claims; and a variety of other information relevant to health plans in carrying out their activities and recovering expenses from third parties. A processor and software engine is associated with the server 41 for correlating the drug, diagnosis, and/or treatment codes, as well as other information, to permit the health plan to recover costs from liable third parties.

Embodiments of methodologies encompassed by the present invention are provided in the following examples:

An embodiment of the present invention applies to prescription drug liability claims. As an example, the prescription drug Rezulin was the subject of lawsuits for causing liver damage. The liver damage led to treatments such as liver transplants or dialysis which obviously resulted in significant costs to the health plans. Unless the plan participants made the health plan aware of the potential claim regarding Rezulin, the health plan did not recover in those cases.

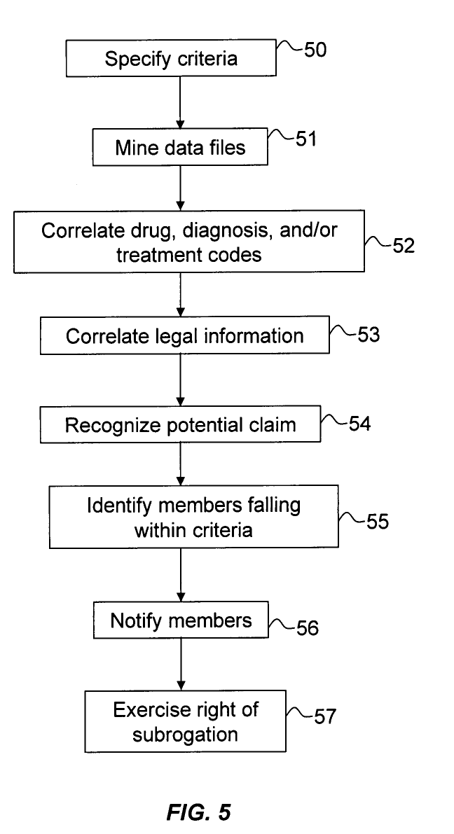

Referring to FIG. 5, an embodiment of the present invention empowers the health plan by providing a method for specifying a criteria 50 and mining pertinent data files 51 to determine whether or not there is a potential claim to recover costs from a negligent third party. Therefore, if the plan member took Rezulin and has liver damage, an embodiment of the present invention reveals this information and the potential for a claim by correlating the codes from the various databases associated with the member 52. That is, the specific NDC code for Rezulin is cross-referenced with certain diagnosis codes (e.g., ICD-9 and ICD-10) involving liver damage and/or certain treatment codes (CPT codes) involving dialysis, etc. Other pertinent legal data and/or claim information 53 are also correlated to identify a potential claim 54 and plan members 55 that fall within the criteria. Not only does the health plan benefit, the plan participant would be made aware that he or she has a cause of action against the negligent tortfeasor 56. The health plan may then pursue claims under the right of subrogation or assert a lien against that particular case 57.

A further embodiment of the present invention enables a user to do a simple search using a single diagnosis code to identify a potential claim against a third party. For example, if a plan member is diagnosed with mesothelioma, a type of cancer only caused by asbestos products, that person has a cause of action against the producers of the asbestos products, and the health plan would have a right of subrogation for the costs incurred. A related example would involve identifying a treatment code or a diagnosis code for “foreign body left in during surgery.”

In addition to the examples provided above, embodiments of the present invention can identify occupational disease claims, for example, carpal tunnel syndrome, which traditionally occurs over time and in the scope of employment. Such claims would provide a right of subrogation against the workers compensation carrier. Embodiments can also identify causes of action resulting from a defective medical device, for example, by correlating codes for the implantation of a particular medical device with certain diagnosed or treated illnesses.

Embodiments of the present invention have now been described. It will be appreciated that these examples are merely illustrative of the invention. Many variations and modifications will be apparent to those skilled in the art.

1. A computer implemented method for identifying medical liability claims, comprising the steps of:
executing a search criteria for searching a data record of at least one plan participant of a health plan, wherein the search criteria is designed to identify a potential claim against a third party from which the health plan may recover health care costs expended on the at least one plan participant;
automatically correlating at least two identification codes associated with the at least one plan participant chosen from a group consisting of a drug code, a diagnosis code and a treatment code;
identifying the at least one plan participant as satisfying the search criteria; and
identifying the potential claim against the third party.

2. The method of claim 1 wherein the drug code is a National Drug Code (NDC).

3. The method of claim 1 wherein the diagnosis code is an International Classification of Diseases (ICD) code.

4. The method of claim 1 wherein the treatment code is a Current Procedural Terminology (CPT) code.

5. The method of claim 1 wherein the health plan is a labor union health plan.

6. The method of claim 1 wherein the health plan has a right of subrogation against the third party.

7. The method of claim 1 wherein the data record is in an Excel format.

8. The method of claim 1 further comprising the step of:
automatically generating a letter for notifying the at least one plan participant of the potential claim against the third party.

9. The method of claim 1 further comprising the step of:
automatically correlating information regarding a legal cause of action regarding the at least two identification codes.

10. A computer readable medium on which is encoded program code, the program code comprising:
program code for executing a search criteria for searching a data record of at least one plan participant of a health plan, wherein the search criteria is designed to identify a potential claim against a third party from which the health plan may recover health care costs expended on the at least one plan participant;
program code for automatically correlating at least two identification codes associated with the at least one plan participant chosen from a group consisting of a drug code, a diagnosis code and a treatment code;
program code for identifying the at least one plan participant as satisfying the search criteria; and
program code for identifying the potential claim against the third party.

11. The computer readable medium of claim 10 wherein the drug code is a National Drug Code (NDC).

12. The computer readable medium of claim 10 wherein the diagnosis code is an International Classification of Diseases (ICD) code.

13. The computer readable medium of claim 10 wherein the treatment code is a Current Procedural Terminology (CPT) code.

14. The computer readable medium of claim 10 further comprising:
program code for automatically generating a letter for notifying the at least one plan participant of the potential claim against the third party.

15. The computer readable medium of claim 10 further comprising:
program code for automatically correlating information regarding a legal cause of action regarding the at least two identification codes.

16. An automated system for identifying medical liability claims, comprising:
a processor;
at least one database communicatively coupled to the processor, wherein the at least one database comprises:
a data record of at least one plan participant of a health plan; and
at least two identification codes associated with the at least one plan participant chosen from a group consisting of a drug code, a diagnosis code and a treatment code;
a correlation engine of the processor for correlating the data record of at least one plan participant to a potential claim against a third party from which the health plan may recover health care costs expended on the at least one plan participant; and
a user interface for identifying the at least one plan participant and for identifying the potential claim against the third party.

17. The system of claim 16 wherein the drug code is a National Drug Code (NDC).

18. The system of claim 16 wherein the diagnosis code is an International Classification of Diseases (ICD) code.

19. The system of claim 16 wherein the treatment code is a Current Procedural Terminology (CPT) code.

20. The system of claim 16 wherein the health plan is a labor union health plan.
